(19) United States
(12) Patent Application Publication
(10) Pub. No.: US 2007/0203593 A1
(43) Pub. Date: Aug. 30, 2007

(54) Method for selecting songs and audio playback device thereof

(76) Inventors: Shih-Hsiung Weng, Taipei City (TW); Chong-Khai Ng, Penang (MY)

Correspondence Address: HARNESS, DICKEY & PIERCE, P.L.C., P.O. BOX 8910, RESTON, VA, 20195, US

(21) Appl. No.: 11/360,770

(22) Filed: Feb. 24, 2006

(51) Int. Cl. G06F 17/00

(52) U.S. Cl. 700/94

(57) ABSTRACT

A method for selecting songs is provided, which is applied in an audio playback device. The method comprises obtaining a song file linked with the song title according to the song title selected by a user; reading a section from the song file according to the section of the song file designated by the user; providing a corresponding section number to the section; establishing a link between the song title and the section number for the section; joining up each section; and adding the song file linked with the section to a playlist according to the selected section and an instruction for adding it to the playlist.

### BACKGROUND OF THE INVENTION

1. Field of Invention

The present invention relates to a method for selecting songs and an audio playback device thereof, and more particularly, to a method for selecting songs and an audio playback device thereof with a function of trial listen to select songs to add into a playlist.

2. Related Art

Nowadays, the audio playback device of digital audio format, such as MP3 player, is becoming popular, since it is capable of storing a large amount of music data and is light, convenient for carrying. However, as the digital audio playback device can store a large amount of music data, when the user is listening to music with the digital audio playback device, he/she cannot associate the displayed song title with the corresponding music style due to human's limited memory, and he/she usually needs to listen to a part of the music to determine whether to listen to it or not. Therefore, it cannot be determined whether a piece of music has been selected correctly or not until the music is added into the playlist and formally played. If wrong, the playlist must be re-modified. When a large number of songs are stored in the playback device, the situation becomes even worse. If many undesired songs are selected, such a fussy step must be repeated constantly, and it is a waste of time and spirit for the user. Furthermore, when the user searches for one or more desired songs by playing songs one by one, recording by paper and pen, and settings songs, for example, deleting songs, or adding songs, according to the record, this brings troubles to the user and also wastes the user's time.

### SUMMARY OF THE INVENTION

In view of above problems, an object of the present invention is to provide a device and method useful for various audio playback devices, such as the Multi Media Viewer (MMV), MP3 player, PVR, and other acoustic devices, enabling the user to pre-select a fast-played song, set a start point for playing each song, and select a duration for play for each song, so as to quickly pre-listen the selected song. In view of above problems, another object of the present invention is to provide a device and method useful for various audio playback devices, such as the MMV, MP3 player, PVR, and other acoustic devices, enabling the user to pre-listen a section of each song to determine whether to add it to the playlist or not depending on preference for the song, or to replay the section or even play the whole song.

In view of the above problems, another object of the present invention is to provide a device and method useful for various audio playback devices, such as the MMV, MP3 player, PVR, and other acoustic devices, enabling the user, when pre-listening the section of each song, to pause the playing before the section has been played for a set duration, or automatically asking the user whether to add the song into the playlist or not, after completing the playing of the set section.

To achieve above objects, the present invention provides a method for selecting songs, applied in an audio playback device. The method comprises obtaining a song file linked with the song title according to a song title selected by a user; reading the section from the song file according to a section of the song file designated by the user; assigning a corresponding section number to the section; establishing a link between the song title and the section number for the section, and displaying it in a correlation table; connecting each section; and adding the song file linked with the section to the playlist according to the selected section and the instruction for adding it to the playlist.

The method further comprises playing the song file linked with the section according to the selected section and instruction, or replaying the section according to the selected section and instruction.

To achieve above objects, the present invention provides an audio playback device, which comprises:

an acoustic data memory module, for recording each song file selected for processing, to be provided to the acoustic signal editing and processing module subsequently, for processing the basic signal data of each selected song;

a trial-play setting memory module, for memorizing the selected song titles and song sections, establishing and memorizing a correlation table in which the song titles are linked with the song section numbers for each song section, to be provided to the acoustic signal editing and processing module subsequently, as basic control data for processing the selected song section; and

an acoustic signal editing and processing module, for decomposing, copying, cutting, integrating, and editing the acoustic data, such that any section of any song can be read from the acoustic data memory module and stored in the trial-play setting memory module, and the individual sections are integrated as a successive audio file for the user to pre-listen, and the song file linked with the section is added into the playlist to be played, according to the selected section and instruction; or playing the song file linked with the section, according to the selected section and instruction; or replaying the section, according the selected section and instruction.

Or, replaying the song file linked with the sections, according to the selected section and instruction.

Furthermore, the audio playback device further comprises a storage module, for storing song files of various formats, for the users to select and play subsequently; a display, for displaying the song title, time parameter, and other records of the song file; and a file access control module, for detecting, extracting, transmitting, coding, and managing the communication of the song files.

The audio playback device is, for example, a MMV, MP3 player, or PVR.

The detailed features and advantages of the present invention will be described in detail in the detailed description of the invention, and the content thereof enables any skilled in the art to understand the technique of the present invention and to implement accordingly, and any advantages and objects related to the present invention can be understood from the disclosures, claims, and drawings of the specification.

The above summary of the present invention and the following detailed description of the invention are used for exampling and explaining the principle of the present invention, and provide a further explanation for the claims of the present invention.

The features and practices of the present invention are illustrated in a most preferred embodiment with reference to the drawings as follows. To further understand the objects, constructions, features, and functions of the present invention, the present invention is illustrated in detail with reference to embodiments as follows.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIGS. 1A and 1B are respectively a front view and a side view of a device which can use the present invention according to a preferred embodiment;

FIG. 2A to 2B are flow charts of a display screen of a device using a method of the present invention according to a preferred embodiment;

FIG. 3 is a block diagram of a device according to a preferred embodiment of the present invention;

FIG. 4 is a schematic view of processing the waveform of the trial song by the method of the present invention;

FIG. 5 is a main flow chart of the method of the present invention;

FIG. 6 is a flow chart of selecting the trial song file and setting the play mode in the method of the present invention (Flow A);

FIG. 7 is a flow chart of processing the selected trial song by the system in the method of the present invention (Flow B);

FIG. 8 is a flow chart of trial-playing the song file by the system in a set mode in the method of the present invention (Flow C);

FIG. 9 is a flow chart of adding the song file set by the system according to the user's instruction to a formal play mode into the playlist to be played (flow D);

FIGS. 10A and 10B are schematic views of obtaining and recording a correlation of the song title and the section number by the trial-play setting and playlist memory module respectively; and

FIG. 10C shows a preferred embodiment of a display for displaying the song and the songs in the playlist.

### DETAILED DESCRIPTION OF THE INVENTION

It should be declared at first that the below drawings are only a brief illustration, and are not drawn according to actual size, that is, they do not reflect the actual functions and characteristics of the present invention.

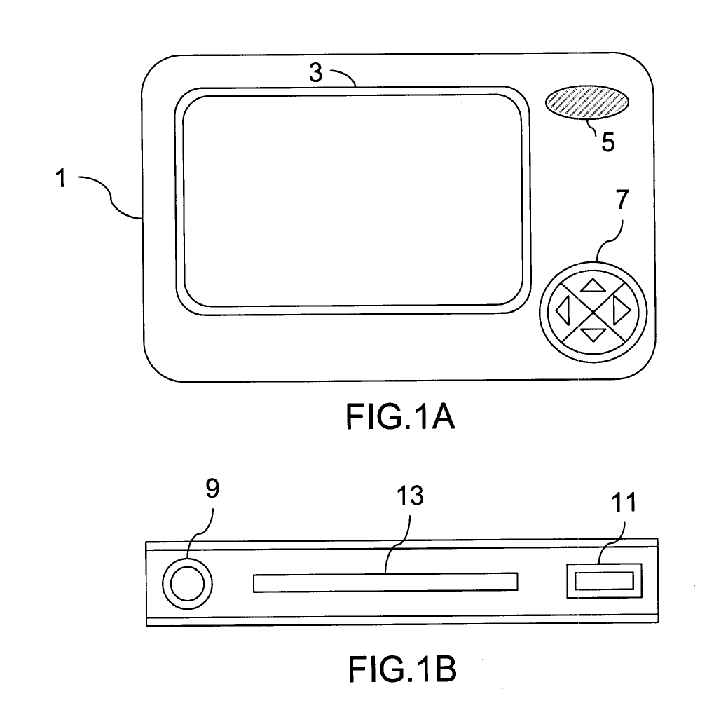

Referring to FIGS. 1A and 1B, they are respectively a front view and a side view of an audio playback device which can use the present invention according to a preferred embodiment.

As shown in FIGS. 1A and 1B, an audio playback device 1 using the present invention, such as a MMV, MP3 player, PVR, or other audio playback devices, may comprise a display 3, a loudspeaker and a loudspeaker hole 5 comprised thereof, a control key 7, an audio signal output jack 9, and a file transport socket 11.

With the display 3, the above audio playback device 1 may display messages, such as the song title, song remaining time, and song serial number. And the users may operate the functions of the audio playback device 1 with the control key 7, for example, controlling the computer system to transfer the music file from the file transport socket 11 to the audio playback device 1, or select songs, and listen to music by the loudspeaker hole 5 or by inserting an earphone into the audio signal output jack 9.

Also, the audio playback device 1 may comprise a memory medium socket 13, for a medium for storing the audio files or a medium for storing other files of various formats to insert.

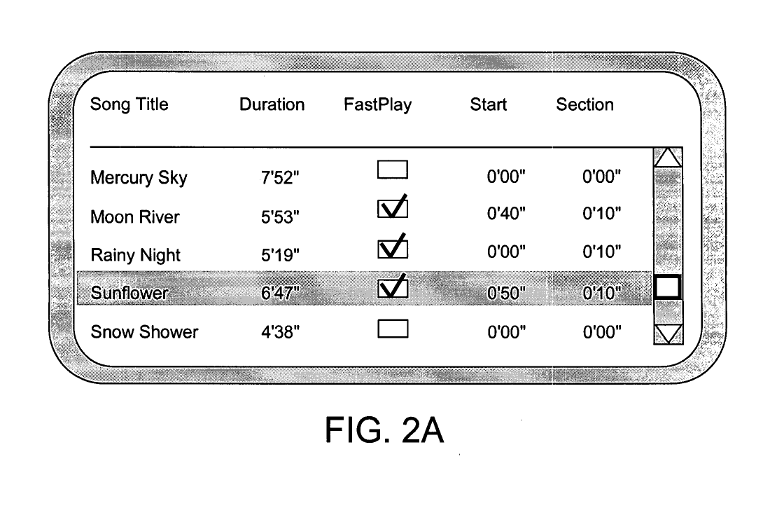

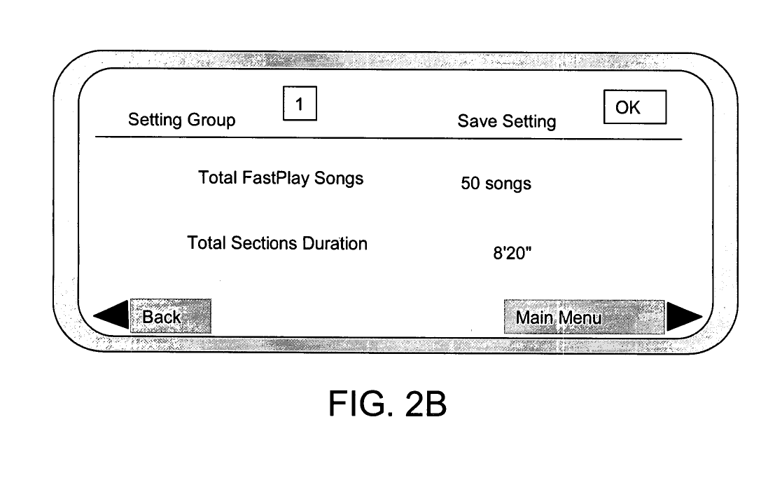

Referring to FIGS. 2A to 2B, they are flow charts of a display screen of a device using a method of the present invention according to a preferred embodiment.

As shown in FIGS. 2A and 2B, the user may pre-select the fast-played songs, set the start point of each song and select the duration for playing each song, and also the total number and time of the songs to be trial-played is displayed after the user has selected the songs for fast playing (trial playing).

Also, the device applying the present invention may allow the user to select whether to add it to the playlist after each song section has been played, or to pause the playing before the pre-listened section has been played completely, or to select to replay the pre-listened section, or even play the whole song.

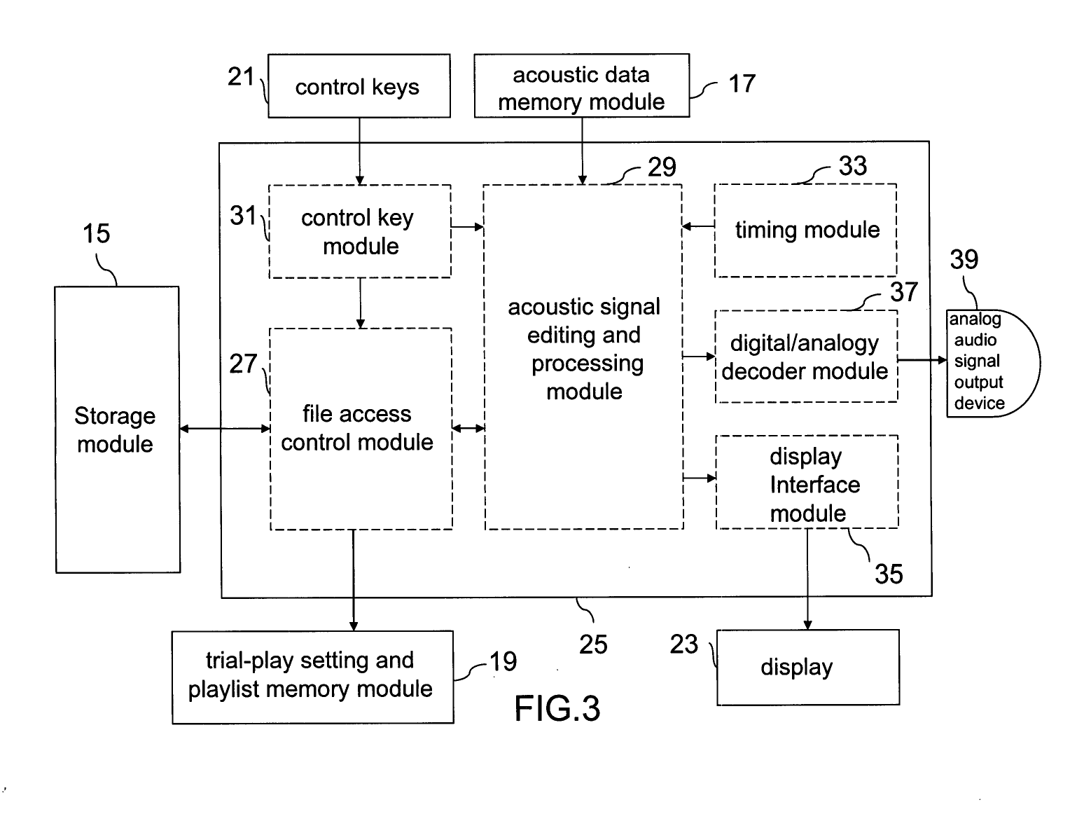

Referring to FIG. 3, it is a block diagram of a device according to a preferred embodiment of the present invention.

As shown in FIG. 3, the device of the present invention comprises a storage module 15, an acoustic data memory module 17, a trial-play setting and playlist memory module 19, a set of control keys 21, a display 23, and a microprocessor 25.

The microprocessor 25 further comprises a file access control module 27, an acoustic signal editing and processing module 29, a control key module 31, a timing module 33, a display interface module 35, and a digital/analogy decoder module 37.

The storage module 15 is used to store files of various formats, for example music files of MP3 format, for a user to select and play subsequently.

The trial-play setting and playlist memory module 19 is used to memorize parameter data recodes such as the selected trial song and time duration, playlist, and the correlation record of song title and section number, for being provided to the acoustic signal editing and processing module 29 subsequently, as basic control data for processing the song section and the playlist.

The acoustic data memory module 17 is used to record each song file selected for processing, comprising the data record, such as sample rate, resolution, file size, file format, duration, sample number, and waveform, for being provided to the acoustic signal editing and processing module 29 subsequently to process the basic signal data of a song section.

The control key 21 is used as an interface for the user to input the control data.

The display 23 may display the records such as song title and time parameter.

The operation core of the present invention is the microprocessor 25, with functions of editing and processing the waveform of the song, managing the file of the playlist, processing the digital/analogy audio signals, and the like.

The key control module 31 generates a control data signal based on the input signal of the control key 21, to control other modules, such as selecting songs.

The file access control module 27 is used to detect, extract, transmit, code, and manage the communication of the files.

The acoustic signal editing and processing module 29 is used to decompose, copy, cut, integrate, and edit the acoustic signal, such that any section of any song can be selected, and the individual sections can be integrated as a successive audio file for the user to pre-listen.

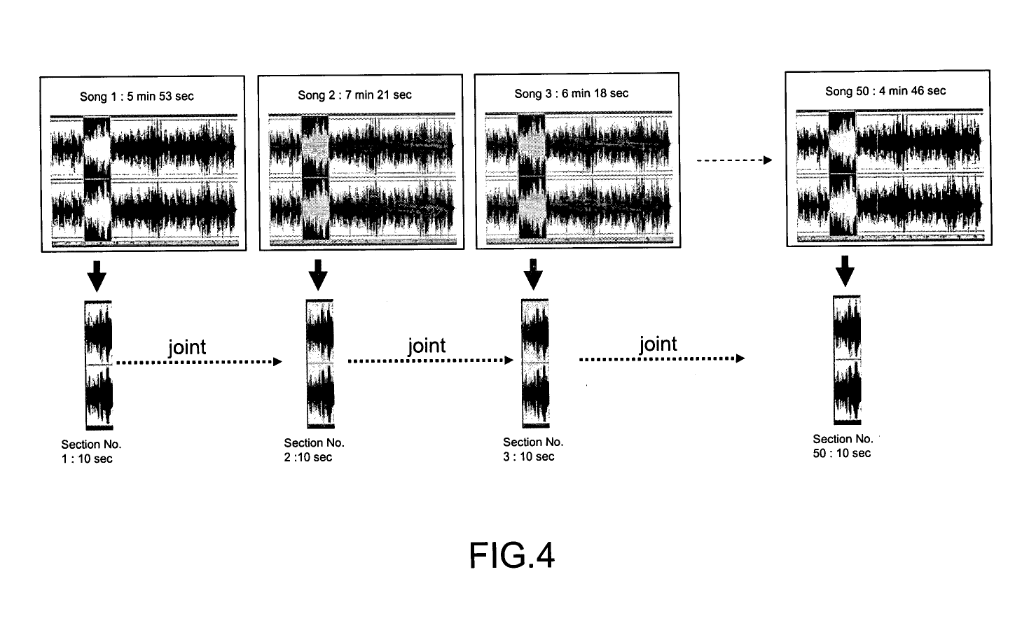

As shown in FIG. 4, according to the start point of each song set by the user and the duration for playing each song selected by the user, the acoustic signal editing and processing module 29 will select a corresponding section, having a start point and an end point, from the play waveform of each song. After the selection is completed, all sections would be joined up as a successive audio file for quick pre-listening.

The timing module 33 is used to provide a source of a time driving signal when the acoustic signal editing and processing module 29 is processing the song sections.

The display interface module 35 is used to convert the time parameters and other data signals of various songs to be output on the display 23.

The digital/analogy decoder module 37 is used to convert the digital sound signal to an analog sound signal, to be output by the analog audio signal output device 39, such that the user may listen to music with a loudspeaker or an earphone.

Then, the method flow of the present invention will be illustrated in detail by each module in the device.

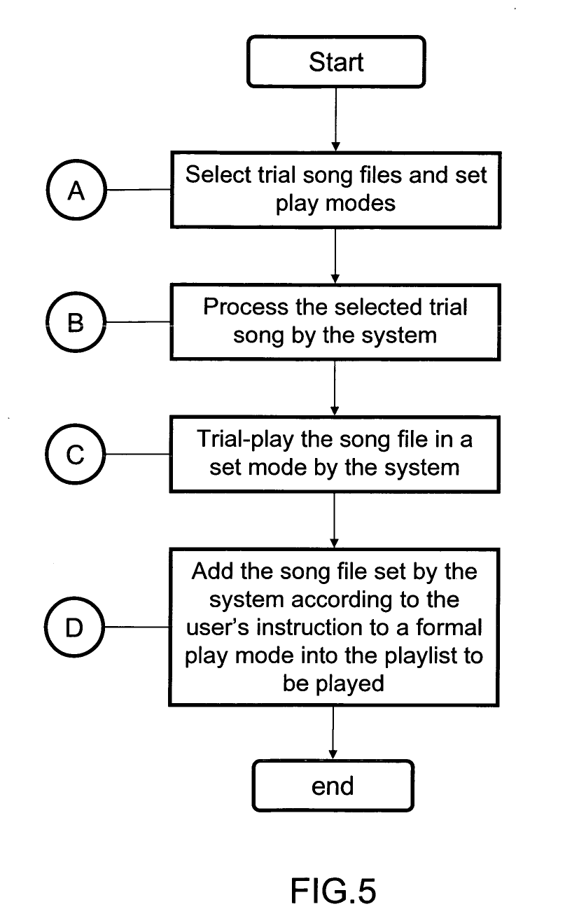

Referring to FIG. 5, it is a main flow chart of a method of the present invention method.

At the beginning, select the trial song files and set the play mode (Flow A); then the system processes the selected trial song (Flow B); the system trial-plays the song file in a set mode (Flow C); the system adds the song file set to a formal play mode according to the user's instruction into the playlist to be played (Flow D).

The secondary flows in the main flow of the method of the present invention will be illustrated in detail below.

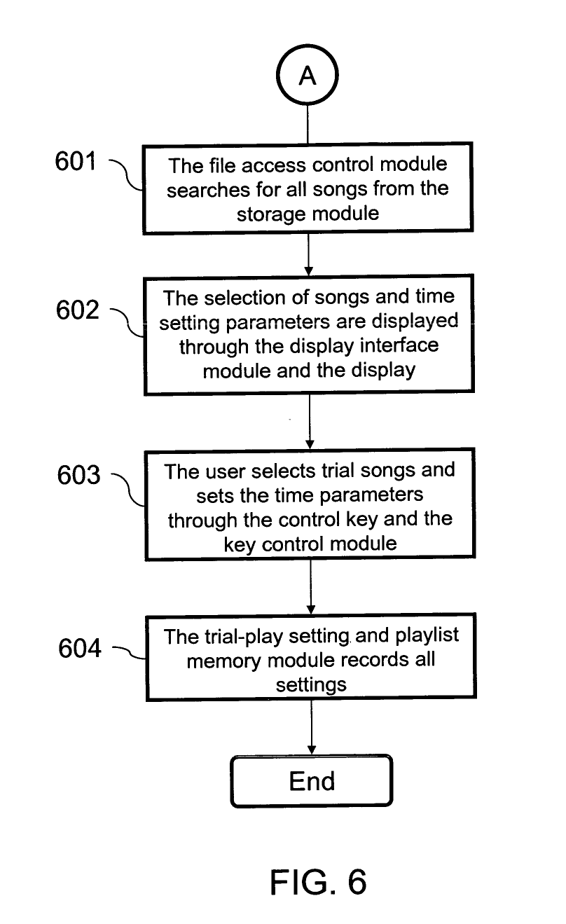

Referring to FIG. 6, it is a flow chart of selecting trial song files and setting play modes (Flow A) in the method of the present invention.

As shown in FIG. 6, in the flow of selecting trial song files and setting play modes (Flow A), the file access control module 27 searches for all songs from the storage module 15 (Step 601); the selection of songs and time setting parameters, such as whether to add it to the pre-playlist or not and start point of the trial section, are displayed through the display interface module 35 and the display 23 (Step 602); the user selects trial songs and sets the time parameters, such as the start point and end point of the trial song, through the control key 21 and the key control module 31 (Step 603); and then the trial-play setting and playlist memory module 19 records all settings (Step 604).

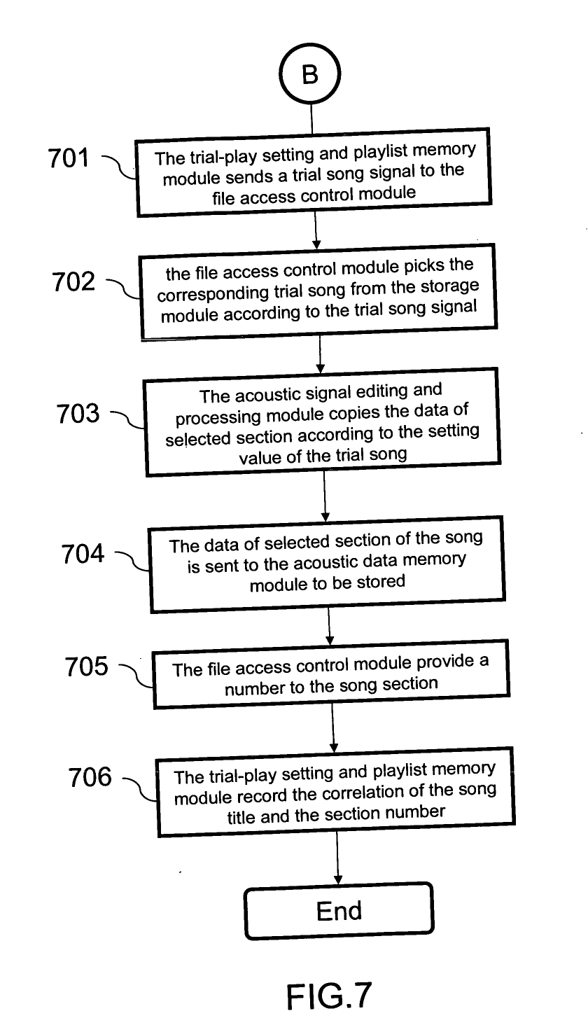

Referring to FIG. 7, it is a flow chart of processing the selected trial song by the system in the method of the present invention (Flow B).

As shown in FIG. 7, in the flow of processing the selected pre-play song by the system (Flow B), the trial-play setting and playlist memory module 19 sends a trial song signal to the file access control module 27 (Step 701); the file access control module 27 picks the corresponding trial song from the storage module 15 according to the trial song signal (Step 702); the acoustic signal editing and processing module 29 copies the data of selected section according to the setting value of the trial song (Step 703); and the data of selected section of the song is sent to the acoustic data memory module 17 to be stored (Step 704).

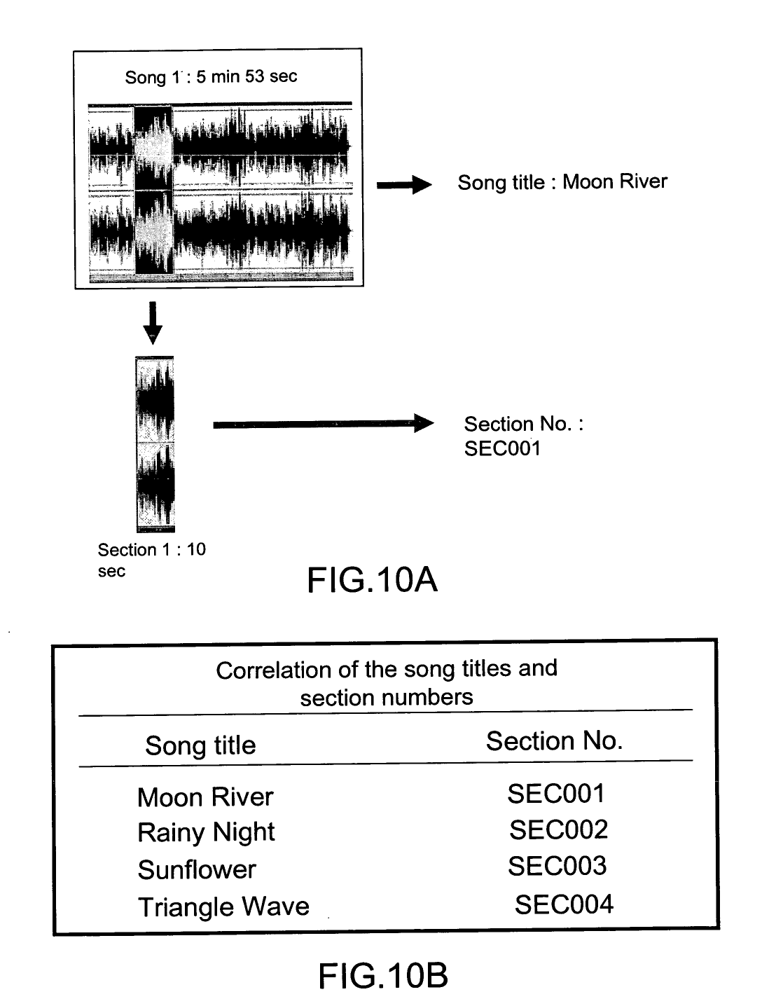

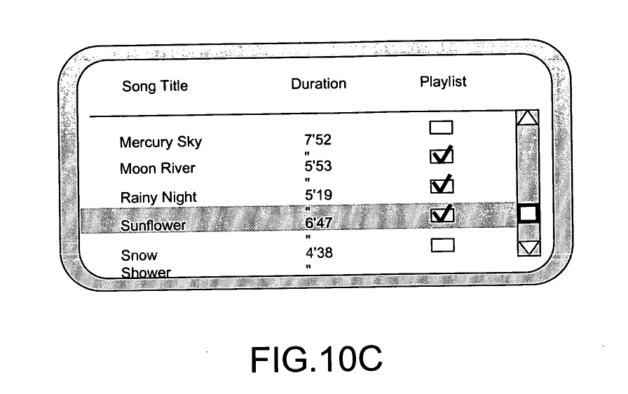

Furthermore, referring to FIGS. 10A and 10B, they are schematic views of a correlation of the song titles and section numbers obtained and recorded by the trial-play setting and playlist memory module.

As shown in FIGS. 10A and 10B, the file access control module 27 may provide a number to the song section (Step 705), and then the trial-play setting and playlist memory module 19 may record the correlation of the song title and the section number (Step 706).

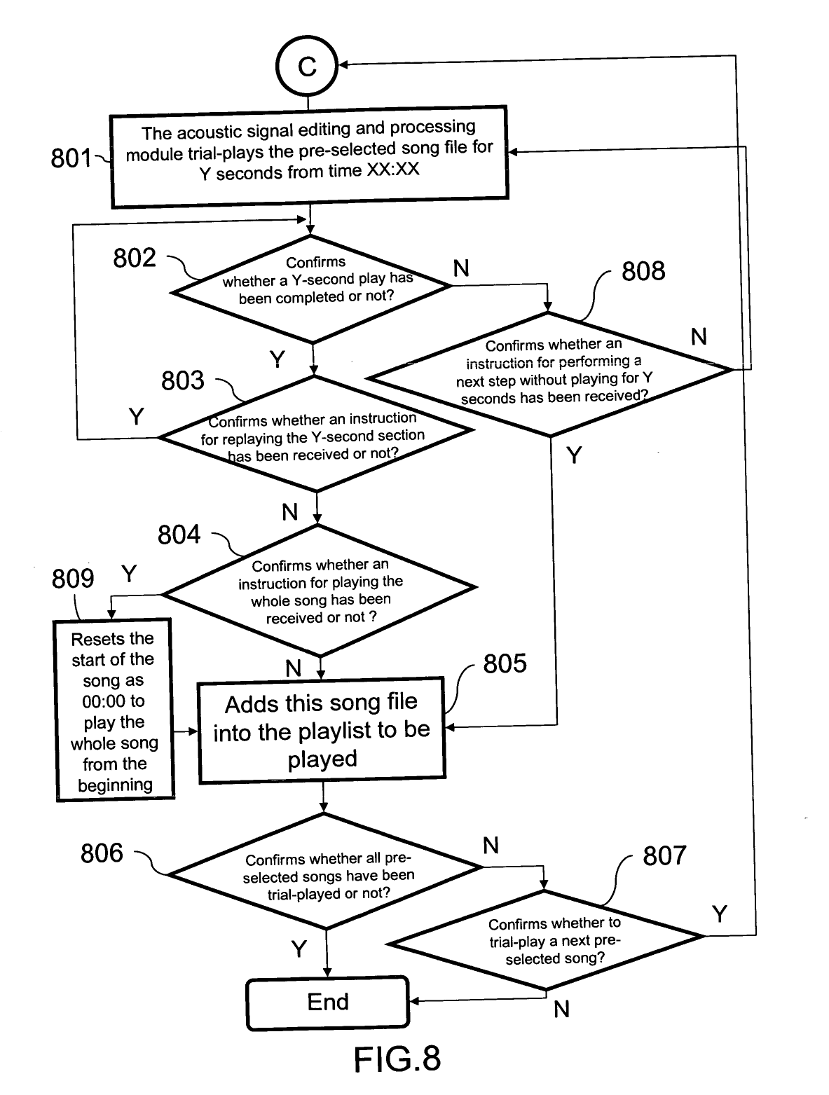

Referring to FIG. 8, it is a flow chart of trial-playing the song file in a set mode by the system (Flow C) in the method of the present invention.

As shown in FIG. 8, in the flow of trial-playing the song file in a set mode by the system (Flow C), according to the setting of the trial song, the acoustic signal editing and processing module 29 trial-plays the pre-selected song file for Y seconds from time XX:XX (Step 801); then confirms whether a Y-second play has been completed or not (Step 802); if yes, it confirms whether an instruction for replaying the Y-second section has been received or not (Step 803); if no, it confirms whether an instruction for playing the whole song has been received or not (Step 804); if no, it adds this song file into the playlist to be played when it is confirmed that an instruction of adding this song file into the playlist has been received (Step 805); then, it confirms whether all pre-selected songs have been trial-played or not (Step 806); if no, it confirms whether to trial-play a next pre-selected song (Step 807); if yes, it returns to the beginning of this Flow C; if no, it ends the Flow C.

In the step of confirming whether the Y-second play has been completed or not (Step 802), if no, it continues to confirm whether an instruction for performing a next step without playing for Y seconds has been received (Step 808); if yes, it adds this song file to the playlist to be played when it is confirmed that an instruction of adding this song file to the playlist has been received (Step 805); if no, it continues to Step 801.

Furthermore, in the step of confirming whether an instruction of playing the whole instruction has been received or not (Step 804); if yes, it resets the start of the song as 00:00 to play the whole song from the beginning (Step 809).

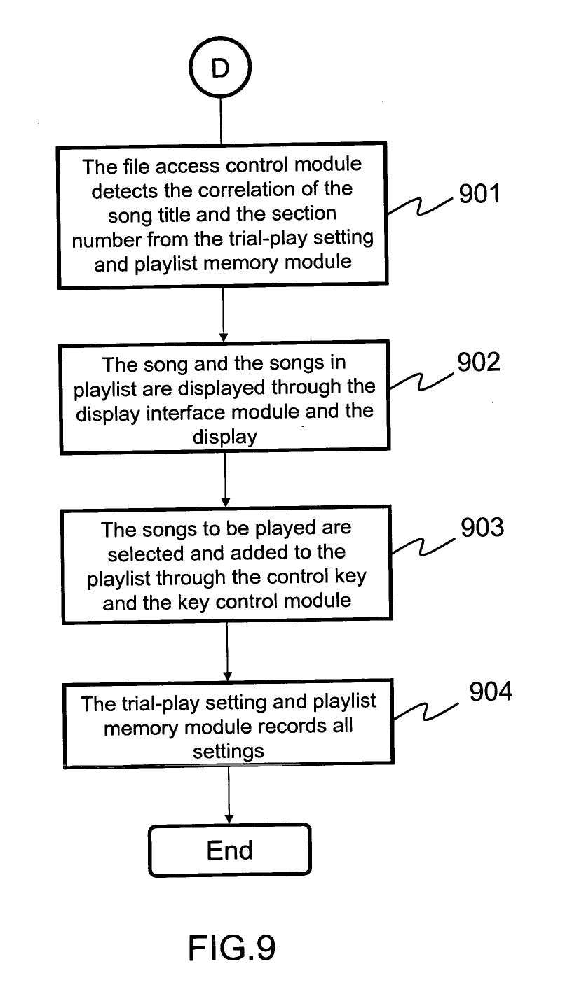

Referring to FIG. 10C together with FIG. 9, wherein FIG. 9 is a flow chart of adding the song file set by the system according to the user's instruction to formal play mode into the playlist to be played (Flow D), and FIG. 10C shows a preferred embodiment of a display for displaying the song and the songs in the playlist.

As shown in FIGS. 9 and 10C, in the flow of adding the song file set by the system according to the user's instruction to a formal play mode into the playlist to be played (Flow D), the file access control module 27 detects the correlation of the song title and the section number from the trial-play setting and playlist memory module 19 (Step 901); displays the song and the songs in playlist through the display interface module 35 and the display 23 (Step 902); selects and adds the songs to be played to the playlist (shown in FIG. 10C) through the control key 21 and the key control module 31 (Step 903); and then the trial-play setting and playlist memory module 19 records all settings (Step 904).

To sum up, the device and method provided by the present invention enable the users to pre-select fast-played songs, set a start point and duration for playing each song to quickly pre-listen the selected songs. Therefore, the probability of selecting an undesired song when unfamiliar with song titles is reduced, thereby reducing the time wasted by repeatedly selecting songs. The system provides a trial-listening function capable of selecting multiple songs, and therefore, the inconvenience of single selecting and single trial-listening is reduced. Furthermore, the system provides a function of selecting songs to add into the playlist depending on a determination made after listening, and therefore, the inconvenience caused by the conventional technique, for example the complicated process wherein the songs to be added to the playlist are recorded by paper and pen, or the songs are recorded by paper and pen after being trial-listened again and again, is reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for selecting songs, applied in an audio playback device, comprising:
obtaining a song file linked with a song title, according to the song title selected by a user;
reading a section from the song file, according to the section of the song file designated by the user;
providing a corresponding section number to the section;
establishing a link between the song title and the section number;
joining up each section; and
adding the song file linked with the section to a playlist, according to the selected section and the instruction for adding to the playlist.

2. The method for selecting songs as claimed in claim 1, wherein the step of designating a section for the song file comprises designating a start point and an end point for the section in the song file.

3. The method for selecting songs as claimed in claim 1, wherein after the step of joining up each section in a correlation table, and before the step of adding the song file linked with the section to a playlist according to the selected section and the instruction, it further comprises a step of playing one of the sections in the correlation table.

4. The method for selecting songs as claimed in claim 3, wherein after the step of playing one of the sections in the correlation table, and before the step of adding the song file linked with the section to a playlist according to the selected section and the instruction, it further comprises a step of replaying the section.

5. The method for selecting songs as claimed in claim 3, wherein after the step of playing one of the sections in the correlation table, and before the step of adding the song file linked with the section to a playlist according to the selected section and the instruction, it further comprises a step of obtaining and playing the song file linked with the section.

6. An audio playback device, comprising:
an acoustic data memory module, for recording each selected song file;
a trial-play setting memory module, for memorizing the selected song titles and song sections, and establishing and memorizing a correlation table in which the song titles are linked with the song section numbers for each song section; and
an acoustic signal editing and processing module, for decomposing, copying, cutting, integrating, and editing the acoustic data, such that any section of any song can be read from the acoustic data memory module and stored in the trial-play setting memory module, and the individual sections are integrated as a successive audio file to be pre-listened by the user, and adding the song file linked with the section to a playlist to be played according to the selected section.

7. The audio playback device as claimed in claim 6, wherein the playlist is stored in the trial-play setting memory module.

8. The audio playback device as claimed in claim 6, wherein it further comprises a storage module for storing song files of various formats for the user to select and display subsequently.

9. The audio playback device as claimed in claim 6, wherein it further comprises a display for displaying the song title, the time parameter, and other records of the song file.

10. The audio playback device as claimed in claim 6, wherein it further comprises a file access control module for detecting, extracting, transmitting, coding, and managing the communication of the song file.
